(19) United States
(12) Patent Application Publication
(10) Pub. No.: US 2009/0010339 A1
(43) Pub. Date: Jan. 8, 2009

(54) IMAGE COMPENSATION CIRCUIT, METHOD THEREOF, AND LCD DEVICE USING THE SAME

(75) Inventors: Ching-Hsiang Hsu, Taipei City (TW); Ling-Chih Lu, Hsinchu County (TW); Shih-Chieh Lu, Taipei County (TW)

Correspondence Address: J C PATENTS, INC., 4 VENTURE, SUITE 250, IRVINE, CA, 92618, US

(73) Assignee: FARADAY TECHNOLOGY CORP., Hsinchu (TW)

(21) Appl. No.: 11/773,875

(22) Filed: Jul. 5, 2007

(51) Int. Cl. H04N 7/32

(52) U.S. Cl. 375/240.17; 375/E07.243

(57) ABSTRACT

Input image signals are spatially and temporally compensated. First, gray scales of a target pixel in a current frame and in a previous frame are compared to determine whether to spatially and temporally compensate the input image signals or not. Next, in accordance to weight parameters and gray scales of pixels adjacent to the target pixel, the target pixel of the current frame is spatially compensated. Further, based on the gray scale of the target pixel of the previous frame, the target pixel of the current frame after spatial compensation is temporally compensated.

### BACKGROUND OF THE INVENTION

1. Field of the Invention

The present invention relates to an image compensation circuit, a method thereof, and an LCD device using the same. More particularly, the present invention relates to an image compensation circuit, a method thereof, and an LCD device using the same, in which images can be spatially and temporally compensated.

2. Description of Related Art

The slow response time of TFT-LCD easily causes problems such as poor dynamic image contrast and motion blurry. The dynamic image contrast can be improved by accelerating the gray-scale transition of liquid crystal materials. However, as for LCD-TV sets, the result is still not satisfying. Further, even if the gray-scale transition time is shortened to 0 (which is impossible in practice), the problem of motion blurry still exists in the TFT-LCD.

Recently, an overdrive technique has been proposed to solve the above-mentioned problems. According to the overdrive technique, during the gray-scale transition, depending upon the original driving voltage, it is determined whether to apply high or low driving voltages. FIG. 1 is a schematic view of the overdrive technique. In FIG. 1, P_T represents the Tth pixel in the frame; (N−1), N, (N+1) respectively represent consecutive (N−1)th, Nth, and (N+1)th frames; the V_N−1_T and V_N_T respectively represent the driving voltage to be applied to the pixel P_T of the (N−1)th frame and the driving voltage to be applied to the pixel P_T of the Nth frame. As seen from FIG. 1, the overdrive technique can be considered as one of the temporal compensation techniques. However, although the overdrive technique may improve the dynamic image contrast, the problem of motion blurry still exists.

In addition, the dynamic image contrast can be effectively improved by higher frame rate, but the cost is increased accordingly.

Therefore, a compensation technique, capable of effectively improving the dynamic image contrast and solving the problem of motion blurry without increasing the cost, is required.

### SUMMARY OF THE INVENTION

The present invention is directed to an image compensation circuit, a method thereof, and an LCD device using the same, in which temporal compensation is adopted to accelerate the gray-scale response time, so as to improve the dynamic image contrast.

The present invention is further directed to an image compensation circuit, a method thereof, and an LCD device using the same, in which spatial compensation is adopted to enhance the dynamic image contrast and solve the problem of motion blurry.

The present invention is directed to an image compensation circuit of a low cost and a high efficiency, a method thereof, and an LCD device using the same.

As embodied and broadly described herein, the present invention provides an image compensation circuit in an embodiment, which includes a memory, a spatial compensation circuit, and a temporal compensation circuit. The memory stores gray scales of a target pixel and pixels adjacent to the target pixel in a current frame, and a gray scale of the target pixel in a previous frame. The spatial compensation circuit compares the gray scale of the target pixel in the current frame with the gray scale of the target pixel in the previous frame to determine whether to spatially compensate the target image of the current frame or not. If the spatial compensation is to be implemented, the spatial compensation circuit spatially compensates the target pixel in the current frame in accordance with a weight parameter and the gray scales of the pixels adjacent to the target pixel in the current frame. If the spatial compensation circuit has already performed the spatial compensation, the temporal compensation circuit temporally compensates the target pixel in the current frame after the spatial compensation according to the gray scale of the target pixel in the previous frame.

Moreover, the present invention also provides a display device using spatial and temporal compensation in another embodiment. The display device includes a temporal and spatial compensation circuit, a timing controller, a source driver circuit and a gate driver circuit, and a display panel. Under the control of a clock signal and a synchronous control signal, the temporal and spatial compensation circuit stores gray scales of a target pixel in several consecutive frames and gray scales of pixels adjacent to the target pixel, compares to see whether there is any change of the gray scales of the target pixels in the consecutive frames, so as to determine whether to spatially compensate the target pixel in one of the consecutive frames in accordance with a weight parameter and the gray scales of the adjacent pixels. In addition, the temporal and spatial compensation circuit further temporally compensates the target pixel after the spatial compensation according to the gray scale of the target pixel in another one of the consecutive frames. The timing controller receives an output signal of the temporal and spatial compensation circuit. The source driver circuit and the gate driver circuit receive an output signal of the timing controller. The display panel displays an image according to output signals of the source driver circuit and the gate driver circuit.

The present invention also provides an image compensation method in still another embodiment, which includes: comparing a gray scale of a target pixel in a current frame with a gray scale of the target pixel in a previous frame; in response to the comparison result, determining whether to spatially compensate the target pixel of the current frame or not; if the spatial compensation is to be performed, recursively updating the gray scale of the target pixel in the current frame in accordance with a weight parameter and gray scales of pixels adjacent to the target pixel in the current frame; and after the spatial compensation is performed, temporally compensating the target pixel in the current frame after the spatial compensation according to the gray scale of the target pixel in the previous frame.

In order to make the aforementioned features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of the overdrive technique.

FIG. 2 is a schematic block diagram of a display device employing spatial and temporal compensation according to an embodiment of the present invention.

FIG. 3 is a schematic block diagram of a temporal and spatial compensation circuit 21 according to the embodiment of the present invention.

FIGS. 4 and 5 show operation flows of a temporal and spatial compensation.

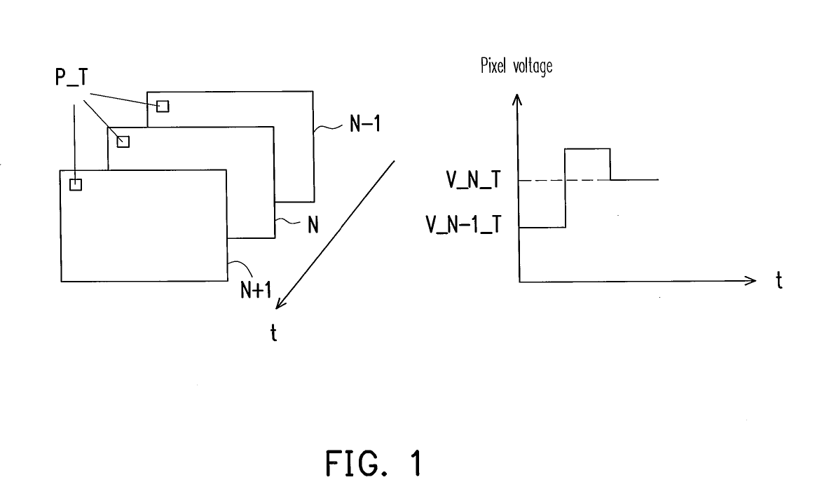

### DESCRIPTION OF EMBODIMENTS

As for the TFT-LCD, the problem of motion blurry is caused by a visual persistence phenomenon of human eyes, which is specifically caused by two possible factors: (1) human eyes can move to trace the path of an object moving at a moderate speed; and (2) at about 60 Hz, the vision system can fully integrate the light stimulus.

In an embodiment of the present invention, several assumptions are proposed to alleviate the problem of motion blurry: (1) the visual system of the human eye usually concentrates on areas having great changes in image contrast; and (2) some part of the visual perception is a function of memory.

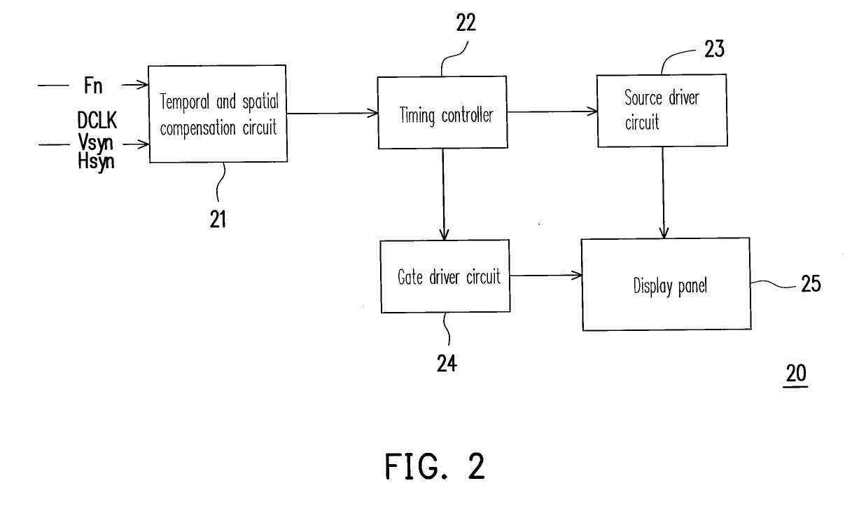

FIG. 2 is a schematic block diagram of a display device employing the spatial and temporal compensation according to an embodiment of the present invention. As shown in FIG. 2, the display device 20 includes a temporal and spatial compensation circuit 21, a timing controller 22, a source driver circuit 23, a gate driver circuit 24, and a display panel 25. In the present embodiment, the architectures of the timing controller 22, the source driver circuit 23, the gate driver circuit 24, and the display panel 25 are not particularly restricted, but other architectures also can be used, as long as they can achieve the required functions.

Under control of a clock signal DCLK, a horizontal synchronous control signal Hsyn, and a perpendicular synchronous control signal Vsyn, the temporal and spatial compensation circuit 21 determines whether to temporally and spatially compensate the frame data Fn or not, and sends output signals (compensated or not compensated) to the timing controller 22. The spatial compensation can be considered as enhancing the contrast of a certain image area.

The timing controller 22 temporally controls output signals of the temporal and spatial compensation circuit 21, and sends output signals to the source driver circuit 23 and the gate driver circuit 24. The display panel 25 displays images according to output signals and driving voltages from the source driver circuit 23 and the gate driver circuit 24.

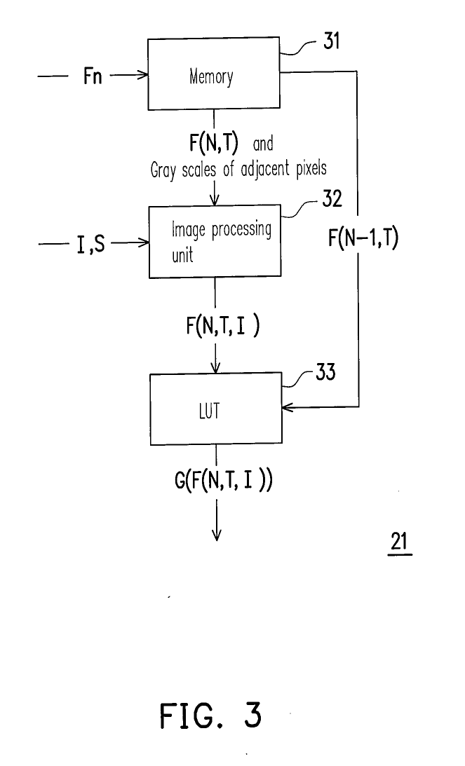

FIG. 3 is a schematic block diagram of the temporal and spatial compensation circuit 21 according to the embodiment of the present invention. As shown in FIG. 3, the temporal and spatial compensation circuit 21 includes a memory 31, an image processing unit 32, and a look-up table (LUT) unit 33.

The memory 31 receives the frame data Fn. In this embodiment, gray scales of some pixels are temporally and spatially compensated. In FIG. 3, the symbol F(N, T) represents the gray scale of the Tth pixel in the Nth frame. Additionally, as the temporal compensation is to be performed, the memory 31 stores the gray scale F(N−1, T) of the Tth pixel in the previous frame (i.e. the (N−1)th frame). In order to further save the cost, the memory 31 may store the effective most significant bit (MSB) of the gray scale F(N−1, T) of the Tth pixel in the previous frame. Of course, the memory 31 of a low cost may cause some marginal effects (such as double edges or blurring tails). If the gray scale of the pixel is of 8-bit, the preset MSB is of 5-bit, and the preset bit number may be varied if necessary.

The memory 31 stores the gray scale F(N, T) of the Tth pixel in the Nth frame and gray scales of adjacent pixels (it is assumed that the gray scales of I pixels in the Nth frame are stored), and sends the gray scales after being delayed for Y clocks to the image processing unit 32, in which I and Y are positive integers. Taking the resolution of 320×240 for example, I is, for example, 5 and Y is, for example, 5.

The memory 31 sends the gray scale F(N, T) of the Tth pixel in the Nth frame and the gray scales of adjacent pixels together to the image processing unit 32, so as to perform the spatial compensation (if needed).

The memory 31 sends the gray scale F(N−1, T) of the Tth pixel in the (N−1)th frame to the LUT unit 33, so as to perform the temporal compensation (if needed).

Besides receiving output signals of the memory 31, the image processing unit 32 further receives parameters I and S. The parameter I represents the number of pixels adjacent to the Tth pixel that should be considered during the spatial compensation. Generally, the higher the display resolution becomes, the larger I will be, and vice versa. The parameter S represents a weight parameter corresponding to an adjacent pixel. Each adjacent pixel is corresponding to a weight parameter. For example, the weight parameters may be obtained by Gaussian function.

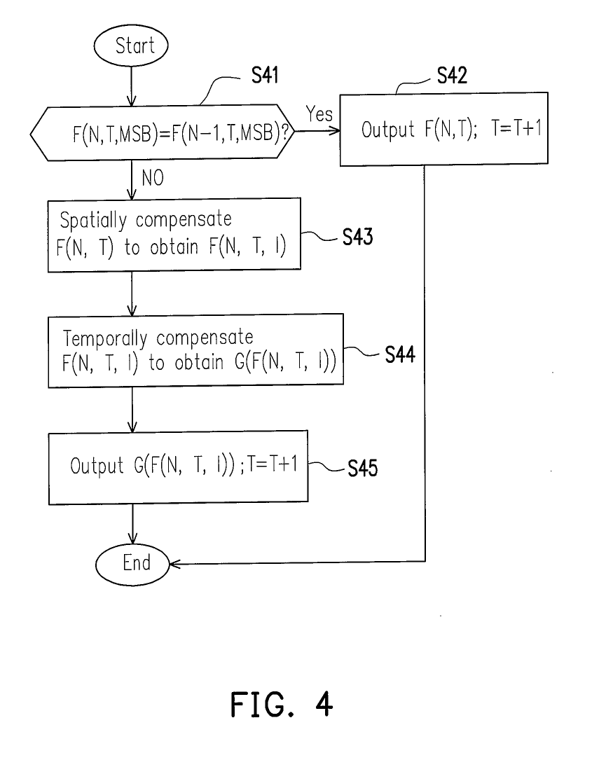

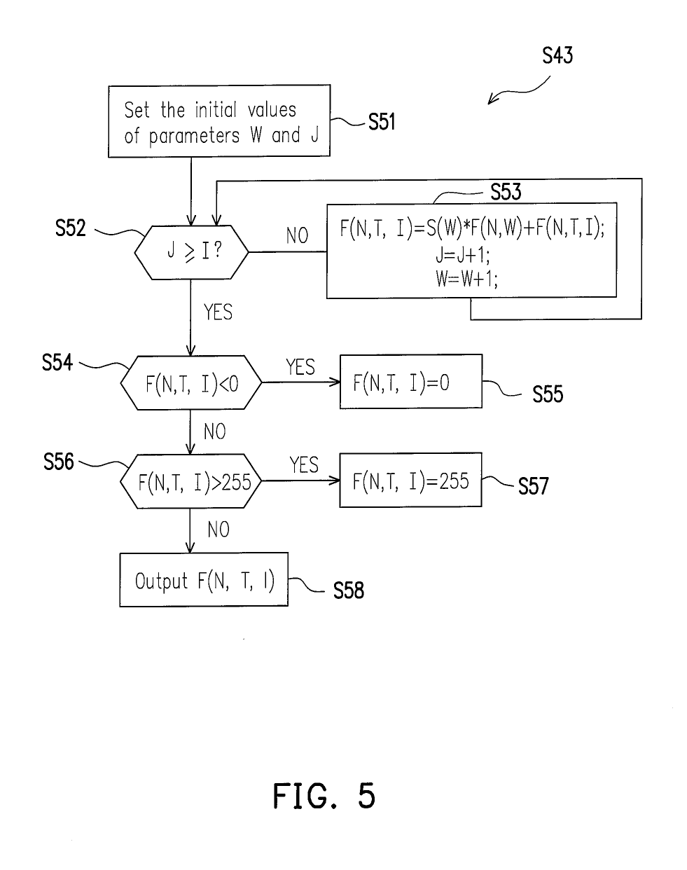

The image processing unit 32 spatially compensates the pixel gray scale F(N, T), and the compensation result is represented by F(N, T, I). The detailed operation of the image processing unit 32 may be described with reference to FIGS. 4 and 5.

The LUT unit 33 temporally compensates the compensation result F(N, T, I) according to the pixel gray scale F(N−1, T), and the temporal compensation result is represented by G(F(T, I)).

In this embodiment, if a pixel is spatially compensated, the pixel is also needed to be temporally compensated. On the contrary, if a pixel is not spatially compensated, the pixel may not be temporally compensated.

How to perform the temporal and spatial compensation in the embodiment can be described with reference to FIGS. 4 and 5.

Referring to FIG. 4, F(N, T) and F(N−1, T) are compared in Step S41. Further, if the memory 31 stores the MSB of F(N−1, T), the MSB of F(N, T) and the MSB of F(N−1, T) are compared in Step S41. In Step S41, F(N, T, MSB) and F(N−1, T, MSB) respectively represent the MSB of F(N, T) and the MSB of F(N−1, T).

If F(N, T) equals to F(N−1, T) (or if F(N, T, MSB) equals to F(N−1, T, MSB)), it indicates that there is substantially no change in the gray scale of the Tth pixel in the two consecutive frames, so that the pixel does not need to be temporally and spatially compensated. Therefore, if the comparison result of Step S41 is YES, i.e., F(N, T) equals to F(N−1, T), it proceeds to Step S42. As shown in Step S42, F(N, T) is output and T is added by 1 (which represents to the next pixel is to be processed).

On the contrary, if F(N, T) does not equal to F(N−1, T) (or if F(N, T, MSB) does not equal to F(N−1, T, MSB)), it indicates that there is some change in the gray scale of the Tth pixel in the two consecutive frames, and thus, the pixel should be temporally and spatially compensated. Therefore, when the comparison result of Step S41 is NO, i.e., F(N, T) does not equal to F(N−1, T), it proceeds to Step S43. As shown in Step S43, F(N, T) is spatially compensated to obtain F(N, T, I). Herein, F(N, T, I) represents the result obtained after spatially compensation on F(N, T). Step S43 is carried out by the image processing unit 32.

Then, as shown in Step S44, F(N, T, I) is temporally compensated to obtain G(F(N, T, I)). Here, G(F(N, T, I)) represents the result of temporally compensation on F(N, T, I). Step S44 is carried out by the LUT unit 33. For example, the LUT unit 33 can obtain G(F(N, T, I)) according to F(N, T, I) and F(N−1, T, I) (if the Tth pixel in the (N−1)th frame is also spatially compensated). Alternatively, the LUT unit 33 can obtain G(F(N, T, I)) according to F(N, T, I) and F(N−1, T) (if the Tth pixel in the (N−1)th frame is not spatially compensated).

Finally, G(F(N, T, I)) is output to back stage circuit (for example, the timing control circuit 22 in FIG. 2) and T is updated (adding T by 1).

Those skilled in the art should understand that, in FIG. 4, the process of updating T is not necessarily performed in Step S45, but may be performed in the comparing step (S41).

How to perform the spatial compensation in this embodiment may be described with reference to FIG. 5.

As shown in Step S51, initial values of parameters W and J are set. The initial value of the parameter J is, for example, 0. The parameter W represents the pixel position adjacent to the Tth pixel that should be considered during the spatial compensation. Generally, the parameter W is relevant to T and I. For example, when I is an odd number, W=T+(I−1)/2; and when I is an even number, W=T+I/2.

Next, in Step S52, it is determined whether J is larger than or equal to I. If J is larger than or equal to I, it indicates that the loop is finished, or the adjacent pixels to be considered are all taken into consideration during the spatial compensation.

If J is smaller than I, the process proceeds to Step S53, otherwise, it proceeds to Step S54.

As shown in Step S53, F(N, T, I)=S(W)*F(N, W)+F(N, T, I), in which S(W) represents a weight parameter of the Wth pixel (adjacent to the Tth pixel), and F(N, W) represents the gray scale of the Wth pixel in the Nth frame. The initial value of F(N, T, I) is F(N, T). After the F(N, T, I) is updated, the parameters W and J are updated. For example, W=W+1 and J=J+1.

Step S53 is repeated till J is larger than or equal to I.

Then, special spatial compensation may be determined, as shown in Steps S54-S57.

As shown in Steps S54 and S55, if F(N, T, I) obtained in Step S53 is smaller than 0, F(N, T, I) is set as 0. Generally, when the Nth pixel is located at the edge of the frame, F(N, T, I) obtained in Step S53 may be smaller than 0.

As shown in Steps S56 and S57, if F(N, T, I) obtained in Step S53 is larger than an upper limit value (taking 8-bit for example, the upper limit value is 255), F(N, T, I) is set as the upper limit value (for example, 255). Generally, when the periphery of the Nth pixel is bright (i.e., the adjacent pixels have a high gray scale), F(N, T, I) obtained in Step S53 may be larger than the upper limit value.

In view of the above, the embodiments of the present invention employ the overdrive technique (i.e., the temporal compensation), to reduce the response time, accelerate the liquid crystal transition speed, and raise the image contrast. Moreover, as the spatial compensation is adopted, the problem of motion blurry may be effectively solved. Furthermore, it is not necessary to raise the frame data rate, so the cost may be reduced and the high efficiency may be achieved.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An image compensation circuit, comprising:
a memory, for storing a gray scale of a target pixel in a current frame, gray scales of pixels adjacent to the target pixel in the current frame, and a gray scale of the target pixel in a previous frame;
a spatial compensation circuit, for comparing the gray scale of the target pixel in the current frame with the gray scale of the target pixel in the previous frame to determine whether to spatially compensate the target pixel in the current frame or not, wherein if the spatial compensation is to be implemented, the spatial compensation circuit spatially compensates the target pixel in the current frame in accordance with a weight parameter and the gray scales of the pixels adjacent to the target pixel in the current frame; and
a temporal compensation circuit, wherein if the spatial compensation is performed by the spatial compensation circuit, the temporal compensation circuit temporally compensates the target pixel in the current frame after the spatial compensation according to the gray scale of the target pixel in the previous frame.

2. The image compensation circuit as claimed in claim 1, wherein if the spatial compensation circuit determines not to perform the spatial compensation, the temporal compensation circuit does not temporally compensate the target pixel in the current frame.

3. The image compensation circuit as claimed in claim 1, wherein the spatial compensation circuit compares the most significant bit (MSB) of the gray scale of the target pixel in the current frame with MSB of the gray scale of the target pixel in the previous frame to determine whether to spatially compensate the target pixel in the current frame.

4. The image compensation circuit as claimed in claim 1, wherein the temporal compensation circuit is a look-up table (LUT) unit.

5. The image compensation circuit as claimed in claim 1, wherein the spatial compensation circuit spatially compensates the target pixel in the current frame, according to a convolution of the weight parameter and the gray scales of the pixels adjacent to the target pixel in the current frame.

6. The image compensation circuit as claimed in claim 5, wherein if the gray scale of the target pixel in the current frame after the spatial compensation is smaller than a lower limit value, the result obtained after the spatial compensation is set as the lower limit value.

7. The image compensation circuit as claimed in claim 5, wherein if the gray scale of the target pixel in the current frame after the spatial compensation is larger than an upper limit value, the result obtained after the spatial compensation is set as the upper limit value.

8. A display device employing spatial and temporal compensation, comprising:
a temporal and spatial compensation circuit, for storing gray scales of a target pixel in consecutive frames and gray scales of pixels adjacent to the target pixel under control of a clock signal and a synchronous control signal, comparing to determine whether there is any change in the gray scales of the target pixels in the consecutive frames, so as to determine whether to spatially compensate the target pixel in one of the consecutive frames in accordance with a weight parameter and the gray scales of the adjacent pixels, and to temporally compensate the target pixel after the spatial compensation according to the gray scale of the target pixel in another one of the consecutive frames;
a timing controller, for receiving an output signal of the temporal and spatial compensation circuit;
a source driver circuit and a gate driver circuit, for receiving an output signal of the timing controller; and
a display panel, for displaying an image according to output signals of the source driver circuit and the gate driver circuit.

9. The display device as claimed in claim 8, wherein the temporal and spatial compensation circuit comprises:
a memory, for storing the gray scales of the target pixels in the consecutive frames and the gray scales of pixels adjacent to the target pixel;
a spatial compensation circuit, for comparing MSBs of the gray scales of the target pixels in the consecutive frames to determine whether to spatially compensate the target pixel in the one of the consecutive frames according to a convolution of the weight parameter and the gray scales of the adjacent pixels; and
a temporal compensation circuit, wherein if the spatial compensation is performed by the spatial compensation circuit, the temporal compensation circuit temporally compensates the target pixel in the one of the consecutive frames after the spatial compensation through a look-up table.

10. The display device as claimed in claim 9, wherein if the spatial compensation circuit does not perform the spatial compensation, the temporal compensation circuit does not perform temporal compensation.

11. The display device as claimed in claim 8, wherein if the gray scale of the target pixel after the spatial compensation is smaller than a lower limit value, the result obtained after the spatial compensation is set as the lower limit value.

12. The display device as claimed in claim 8, wherein if the gray scale of the target pixel after the spatial compensation is larger than an upper limit value, the result obtained after the spatial compensation is set as the upper limit value.

13. An image compensation method, comprising:
comparing a gray scale of a target pixel in a current frame with a gray scale of the target pixel in a previous frame;
determining whether to spatially compensate the target pixel in the current frame or not, in response to the comparison result;
if the spatial compensation is determined to be performed, recursively updating the gray scale of the target pixel in the current frame in accordance with a weight parameter and gray scales of pixels adjacent to the target pixel in the current frame; and
after the spatial compensation has been performed, temporally compensating the target pixel in the current frame after the spatial compensation according to the gray scale of the target pixel in the previous frame.

14. The image compensation method as claimed in claim 13, further comprising:
if the spatial compensation is not performed, the temporal compensation is not performed.

15. The image compensation method as claimed in claim 13, wherein the comparing step comprises:
comparing to determine whether MSB of the gray scale of the target pixel in the current frame is the same as the gray scale of the target pixel in the previous frame.

16. The image compensation method as claimed in claim 13, wherein the temporally compensating step comprises: an overdriving step.

17. The image compensation method as claimed in claim 13, wherein the step of recursively updating the gray scale of the target pixel in the current frame comprises:
spatially compensating the target pixel in the current frame according to a convolution of the weight parameter and the gray scales of the pixels adjacent to the target pixel in the current frame.

18. The image compensation method as claimed in claim 13, further comprising:
if the gray scale of the target pixel in the current frame after the spatial compensation is smaller than a lower limit value, setting the result obtained after the spatial compensation as the lower limit value.

19. The image compensation method as claimed in claim 13, further comprising:
if the gray scale of the target pixel in the current frame after the spatial compensation is larger than an upper limit value, setting the result obtained after the spatial compensation as the upper limit value.
